(19) United States
(12) Patent Application Publication
(10) Pub. No.: US 2006/0149791 A1
(43) Pub. Date: Jul. 6, 2006

(54) Database-driven distributed recovery

(75) Inventors: Bipul Sinha, Foster City, CA (US); Amit Ganesh, San Jose, CA (US); Vivekanandhan Raja, Foster City, CA (US)

Correspondence Address: HICKMAN PALERMO TRUONG & BECKER/ORACLE, 2055 GATEWAY PLACE, SUITE 550, SAN JOSE, CA, 95110-1089, US

(73) Assignee: ORACLE INTERNATIONAL CORPORATION, REDWOOD SHORES, CA (US)

(21) Appl. No.: 11/031,275

(22) Filed: Jan. 6, 2005

(51) Int. Cl. G06F 17/30

(52) U.S. Cl. 707/202

(57) ABSTRACT

A method and apparatus for database-driven distributed recovery is provided. According to one aspect, a transaction manager sends, to one or more resource managers, connection information that indicates how to connect to the transaction manager. A resource manager that receives the connection information establishes an association between the connection information and the distributed transaction for which the connection information was received. If the resource manager is ever in doubt concerning whether the distributed transaction should be committed, the resource manager uses the associated connection information to send, to the transaction manager, a request for status information. The transaction manager maintains status information that indicates whether the distributed transaction should be committed, and responds to the resource manager with the requested status information. The resource manager receives the status information and, based on the status information, either commits or rolls back its portion of the distributed transaction.

### FIELD OF THE INVENTION

The present invention relates to distributed transactions, and in particular, to database-driven distributed recovery.

### BACKGROUND

In typical database systems, users store, update and retrieve information by submitting commands to a database application. To be correctly processed, the commands must comply with the database language that is supported by the database application. One popular database language is known as Structured Query Language (SQL).

A logical unit of work that is comprised of one or more database language statements is referred to as a transaction. In a database server, a memory area called the System Global Area (SGA) is allocated and one or more processes are started to execute one or more transactions. The combination of the SGA and the processes executing transactions is called a database instance.

To ensure the integrity of a database, the database must show all the changes made by a transaction, or none of the changes made by the transaction. Consequently, none of the changes made by a transaction are permanently applied to a database until the transaction has been fully executed. A transaction is said to “commit” when the changes made by the transaction are made permanent to a database.

A single transaction may involve accessing data within multiple data storage resources, such as databases. Each separate data storage resource may be managed by a separate “resource manager,” such as a database server. For example, a distributed transaction may involve debiting one bank account that is stored on one data storage resource, and crediting another bank account that is stored on another data storage resource. When a transaction involves accessing data within multiple data storage resources, the transaction is “distributed” among the data storage resources.

If at least one operation of a distributed transaction cannot be completed relative to at least one of the data storage resources involved in the distributed transaction, then all of the data storage resources need to be restored to their states prior to the performance of any of the operations of the distributed transaction. For example, two data storage resources might be involved in a distributed transaction. If the operations related to the first data storage resource can be completed, but the operations related to the second data storage resource cannot be completed, then both the first data storage resource and the second data storage resource need to be restored to the states in which those data storage resources were prior to the performance of the operations. In the context of databases, this restoration is called “rollback.”

To ensure the atomicity of distributed transactions, a transaction processing monitor, or “transaction manager,” may coordinate the actions of resource managers involved in the distributed transactions. According to one approach, a transaction manager coordinates the actions of resource managers using a “two-phase commit” protocol.

In the first phase of the two-phase commit protocol, the transaction manager sends a request to each resource manager that is involved in a distributed transaction. Each request is an invitation to a recipient resource manager to perform a portion of the distributed transaction, and then to indicate to the transaction manager whether the recipient resource manager is prepared to commit its portion of the distributed transaction. If the recipient resource manager is prepared to commit its portion of the distributed transaction, then the recipient resource manager sends a response that indicates, “prepared.” Alternatively, if the recipient resource manager is unable to perform its portion of the distributed transaction, then the recipient resource manager sends a response that indicates, “abort.”

Once the transaction manager has received either a “prepared” response from each resource manager that is involved in the distributed transaction or an “abort” response from any resource manager that is involved in the distributed transaction, the second phase of the two-phase commit protocol begins. The transaction manager sends messages to each resource manager. If all of the responses from the resource managers indicated “prepared,” then each message indicates “commit.” Alternatively, if any of the responses indicated “abort,” then each message indicates, “abort.”

If a resource manager receives a “commit” message, then the resource manager commits, to the data storage resource that the resource manager manages, the changes made by the distributed transaction's operations that are related to that data storage resource. In other words, the resource manager makes the changes permanent relative to the data storage resource. Alternatively, if a resource manager receives an “abort” message, then the resource manager rolls back the data storage resource that the resource manager manages, so that the distributed transaction's changes are entirely reversed relative to the data storage resource. In either case, the resource manager sends an acknowledgement to the transaction manager.

For various reasons, the transaction manager might not receive acknowledgements from one or more resources manager that were involved in the transaction. The transaction manager might not receive an acknowledgement from a particular resource manager because communication between the transaction manager and the particular resource manager was interrupted after the particular resource manager received the “commit” or “abort” message from the transaction manager. In this case, the particular resource manager's data storage resource would be in the correct state despite the lost acknowledgement.

Alternatively, the transaction manager might not receive an acknowledgement from the particular resource manager because communication between the transaction manager and the particular resource manager was interrupted before the particular resource manager received the “commit” or “abort” message from the transaction manager. In this case, the particular resource manager's data storage resource might be in an incorrect state. According to one approach, when a resource manager does not receive a message from a transaction manager during the second phase, the resource manager considers the commitment status of the relevant transaction to be “in doubt.” Under such circumstances, the resource manager is not certain whether to commit or roll back the changes involved in the transaction, and needs to receive verification from the transaction manager before doing either.

According to one approach, if the transaction manager does not receive an acknowledgement from a particular resource manager, then the transaction manager assumes the responsibility of ensuring that the particular resource manager's data storage resource is placed in the correct state. Under one approach, in order to ascertain the state of the particular resource manager's data storage resource, the transaction manager needs to have access to configuration information that indicates, for each resource manager, how to connect to that resource manager.

For example, the configuration information may indicate a username and password that the transaction manager needs to supply to the particular resource manager before the particular resource manager will allow the transaction manager to access the particular resource manager's data storage resource. The configuration information might be stored in a separate data repository that is accessible to the transaction manager. Once the transaction manager ascertains whether the particular resource manager is “in doubt” relative to one or more transactions, the transaction manager can instruct the particular resource manager, for each transaction, whether to commit or roll back the changes related to that transaction.

Unfortunately, generating the configuration information for use by the transaction manager can be a task that becomes more onerous as the number of resource managers increases. Additionally, there is a security risk inherent in storing data storage resource access information in a central location that might be accessible to unauthorized parties. An unauthorized party who obtains usernames and passwords for all of the data storage resources can potentially read from and write to all of the data storage resources at will.

These are some of the problems that would attend the above approach. A technique that overcomes these problems is needed.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates a system in which resource managers maintain connection information for connecting to transaction managers, according to an embodiment of the present invention;

FIGS. 2A and 2B are block diagrams that illustrate a technique for recovering a distributed transaction, according to an embodiment of the present invention;

FIGS. 3A and 3B are block diagrams that illustrate a technique for recovering a distributed transaction, according to an embodiment of the present invention; and

FIG. 4 is a block diagram that illustrates a computer system upon which an embodiment of the invention may be implemented.

### DETAILED DESCRIPTION

A method and apparatus is described for database-driven distributed recovery. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

According to one embodiment of the invention, a transaction manager sends, to one or more resource managers, connection information that indicates how to connect to the transaction manager. The connection information may indicate, for example, an “endpoint” of the transaction manager. For example, the endpoint may comprise an identifier of a machine on which the transaction manager executes, and a port number associated with the transaction manager on that machine. The transaction manager may send the connection information to the resource managers during the course of a distributed transaction in which the resource managers participate.

A resource manager that receives the connection information establishes an association between the connection information and the distributed transaction for which the connection information was received. If the resource manager is ever in doubt concerning whether the changes of the distributed transaction should be committed or rolled back, the resource manager uses the connection information associated with the distributed transaction to establish a connection to the appropriate transaction manager. Using this connection, the resource manager sends a request for status information that indicates whether the changes of the distributed transaction should be committed or rolled back.

A transaction manager that receives such a request determines, based on stored status information that is associated with the distributed transaction, whether the changes of the distributed transaction should be committed or rolled back. The transaction manager responds to the resource manager with the requested status information. The resource manager receives the status information and, based on the status information, either commits or rolls back the changes of the transaction relative to the resource manager's data storage resource.

Because the resource manager assumes the responsibility for determining whether changes of an in doubt transaction should be committed or rolled back, there is no need to store information that the transaction manager would need to connect to resource managers. As a result, system administrators are spared the burden of manually generating such configuration information. Avoiding the centralized storage of sensitive access information, which would be needed if the transaction manager had to initiate contact with resource managers, relieves security concerns.

### Transaction Managers and Resource Managers

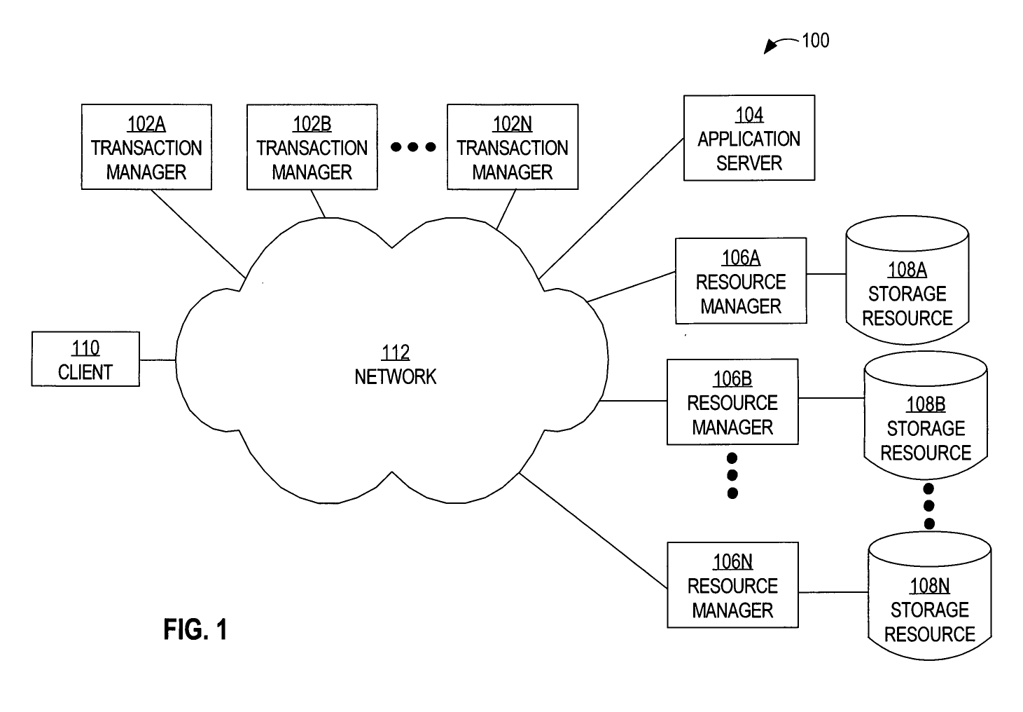

FIG. 1 is a block diagram that illustrates a system 100 in which resource managers maintain connection information for connecting to transaction managers, according to an embodiment of the present invention. System 100 comprises transaction managers 102A-N, application server 104, resource managers 106A-N, data storage resources 108A-N, client 110, and network 112. Transaction managers 102A-N, application server 104, resource managers 106A-N, and client 110 are communicatively coupled to network 112. Data storage resources 108A-N are communicatively coupled to resource managers 106A-N, respectively. Although transaction managers 102A-N are shown separately from application server 104, in one embodiment, application server 104 comprises transaction managers 102A-N.

Transaction managers 102A-N are processes that coordinate distributed transactions among resource managers 106A-N using a two-phase commit protocol. Resource managers 106A-N are processes that retrieve data from and store data to data storage resources 108A-N. For example, resource managers 106A-N may be database servers. Resource managers 106A-N may be different programs from different vendors. In this sense, resource managers 106A-N may be “heterogeneous.” Data storage resources 108A-N are repositories that store data. For example, data storages resources 108A-N may be databases and/or queues.

Client 110 sends requests to and receives responses from application server 104 through network 112. For example, client 110 may send Hypertext Transfer Protocol (HTTP) requests and receive HTTP responses from application server 104. Network 112 may comprise a local area network (LAN), a wide area network (WAN), and/or an inter-network such as the Internet.

Application server 104 comprises business logic for handling and responding to requests received from client 110. Based on requests received from client 110, application server 104 may send commands to resource managers 106A-N. The commands may instruct resource managers 106A-N to perform operations that update data in those of data storage resources 108A-N that those resource managers manage.

### Obtaining Transaction Manager Connection Information

Requests that application server 104 receives from client 110 may require distributed transactions to be performed relative to data in two or more of data storage resources 108A-N. For example, a request may require the debiting of one bank account that is stored on data storage resource 108A, and the crediting of another bank account that is stored on data storage resource 108B. Under such circumstances, the distributed transaction's changes should not be committed in any of data storage resources 108A-N unless the distributed transaction's changes can be committed in all of those of data storage resources 108A-N that are involved in the distributed transaction.

Application server 104 may assign, to a particular transaction manager selected from among transaction managers 106A-N, the task of managing a distributed transaction. According to one embodiment, each of transaction managers 106A-N has a separate machine name and port number that can be used to connect to that transaction manager. Thus, according to one embodiment, the particular transaction manager's machine name and port number comprise the particular transaction manger's “connection information.”

According to one embodiment, the particular transaction manager generates a transaction identifier for the distributed transaction. The particular transaction manager sends the transaction identifier and the particular transaction manger's connection information to application server 104.

Application server 104 sends messages to those of resource managers 106A-N that manage those of data storage resources 108A-N that are involved in the distributed transaction. The messages indicate operations to be performed pursuant to the distributed transaction. Each message indicates the transaction identifier. In one embodiment, each message also indicates the particular transaction manager's connection information.

Resource managers 106A-N maintain state information for each distributed transaction in which they are involved. In one embodiment, the state information indicates an association between (a) the transaction identifier for the distributed transaction and (b) the connection information for the transaction manager that manages the distributed transaction. Thus, a particular resource manager might store a first association between a first transaction identifier and connection information for a first transaction manager, and a second association between a second transaction identifier and connection information for a second transaction manager.

As described above, resources managers 106A-N may receive transaction identifiers and connection information in messages received from application server 104. Protocols conventionally used to communicate information between an application server and a resource manager may be used to convey transaction managers' connection information to resource managers.

### Two-Phase Commit Protocol

In one embodiment, the particular transaction manager assigned to manage a distributed transaction uses a two-phase commit protocol to ensure the atomicity of the distributed transaction. For example, transaction manager 102A may be responsible for a distributed transaction. When application server 104A has finished sending commands to those of resource managers 106A-N that are involved in the distributed transaction (the “involved resource managers”), transaction manager 102A sends, to each involved resource manager, an invitation to indicate to transaction manager 102A whether the involved resource manager is prepared to commit the distributed transaction. In one embodiment, each invitation indicates the connection information for transaction manager 102A.

Assuming that every involved resource manager is ready to commit the distributed transaction, transaction manager 102A receives, from each involved resource manager, a “prepared” response. Alternatively, if at least one involved resource manager is not ready to commit the distributed transaction, transaction manager 102A receives, from at least one involved resource manager, an “abort” response. Inasmuch as transaction manager 102A and resource managers 106A-N may be involved in multiple separate distributed transactions, each “prepared” or “abort” response may indicate the transaction identifier of the distributed transaction to which the response pertains.

Transaction manager 102A stores commitment status information for each distributed transaction that transaction manager 102A manages. For the distributed transaction, the commitment status information indicates which of the involved resource managers have sent a “prepared” response, which of the involved resource managers have sent an “abort” response, and which of the involved resource managers have not yet sent a response. When transaction manager 102A receives a “prepared” response or an “abort” response from one of resource managers 106A-N, transaction manager updates the commitment status information for the appropriate distributed transaction to indicate that the resource manager has sent the “prepared” or “abort” response for that distributed transaction.

If the commitment status information for the distributed transaction indicates that “prepared” responses have been received for all of the involved resource managers, transaction manager 102A sends, to each involved resource manager, a message that instructs the involved resource manager to commit the changes of the distributed transaction. Those of resource managers 106A-N that receive such a commit message commit the changes of the distributed transaction in their associated data storage resources. After committing changes of the distributed transaction, a resource manager sends an acknowledgement to transaction manager 102A. The acknowledgement may indicate, for example, the resource manager's identifier, and the transaction identifier for the distributed transaction.

Alternatively, if the commitment status information for the distributed transaction indicates that an “abort” response has been received from any of the involved resource managers, transaction manager 102A sends, to each involved resource manager, a message that instructs the involved resource manager to roll back the changes of the distributed transaction. Those of resource managers 106A-N that receive such a roll back message roll back the changes of the distributed transaction in their associated data storage resources. After rolling back changes of the distributed transaction, a resource manager sends an acknowledgement to transaction manager 102A. The acknowledgement may indicate, for example, the resource manager's identifier, and the transaction identifier for the distributed transaction.

When transaction manager 102A receives an acknowledgement from one of resource managers 106A-N, transaction manager 102A updates the commitment status information for the appropriate distributed transaction to indicate that the resource manager has sent an acknowledgement for that distributed transaction. When the commitment status information for the distributed transaction indicates that all of the resource managers involved in the distributed transaction have sent acknowledgements, transaction manager 102A no longer needs to store the commitment status information for the distributed transaction. Transaction manager 102A may then erase the commitment status information for the distributed transaction.

### Requesting Commitment Status Information from the Appropriate Transaction Manager

If communication between transaction manager 102A and an involved resource manager is interrupted before the involved resource manager receives the commit or rollback message from transaction manager 102A, the involved resource manager considers the commitment status of the distributed transaction to be “in doubt.” The involved resource manager is not certain whether the changes of the distributed transaction should be committed or rolled back—one of the other involved resource managers might have aborted the transaction. In one embodiment, a resource manager considers the commitment status of a distributed transaction to be “in doubt” if the resource manager does not receive a “commit” or “abort” message from a transaction manager within a specified period of time after the resource manager sent a “prepared” message to the transaction manager.

According to one embodiment, when a particular resource manager of resource managers 106A-N considers the commitment status of a distributed transaction to be “in doubt,” the particular resource manager determines, from the connection information that is associated with the distributed transaction's transaction identifier, how to connect to the transaction manager that manages the distributed transaction. As described above, in one embodiment, the connection information includes the transaction manager's machine name and port number.

Using the connection information, the particular resource manager establishes a connection with the appropriate transaction manager of transaction managers 102A-N. For each separate “in doubt” distributed transaction, a resource manager may establish a separate connection to a separate transaction manager. The connection may be, for example, an HTTP connection. For example, assuming that the “in doubt” distributed transaction is managed by transaction manager 102A, resource manager 106A may establish an HTTP connection with transaction manager 102A based on the connection information for transaction manager 102A that is associated with the “in doubt” distributed transaction.

Through the connection, the particular resource manager sends a request for commitment status information for the distributed transaction. The request indicates the distributed transaction's transaction identifier. In the above example, transaction manager 102A receives the request, and determines, from the commitment status information for the distributed transaction identified by the transaction identifier, whether all of the involved resource managers sent “prepared” messages or if any of the involved resource managers sent an “abort” message.

Through the connection, the appropriate transaction manager sends a response that indicates the commitment status information for the distributed transaction. If all of the involved resource managers sent “prepared” resource messages, then, in this example, transaction manager 102A sends, through the connection, a message that instructs resource manager 106A to commit the changes of the distributed transaction. Alternatively, if at least one of the involved resource managers sent an “abort” message, then, in this example, transaction manager 102A sends, through the connection, a message that instructs resource manager 106A to roll back the changes of the distributed transaction.

Continuing the above example, after either committing or rolling back the changes of the distributed transaction according to the response received from transaction manager 102A, resource manager 106A sends an acknowledgement to transaction manager 102A. As discussed above, when transaction manager 102A has received acknowledgements from all of the involved resource managers, transaction manager 102A may dispose of the commitment status information for the distributed transaction.

### Example Technique Performable by Resource Managers

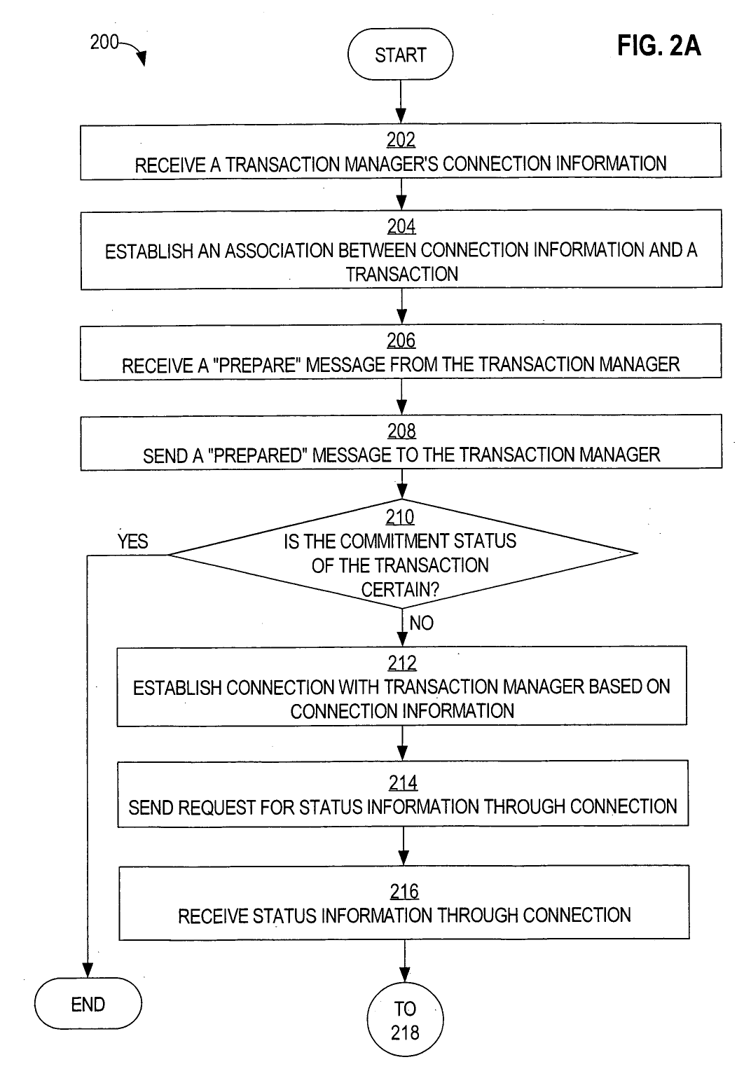

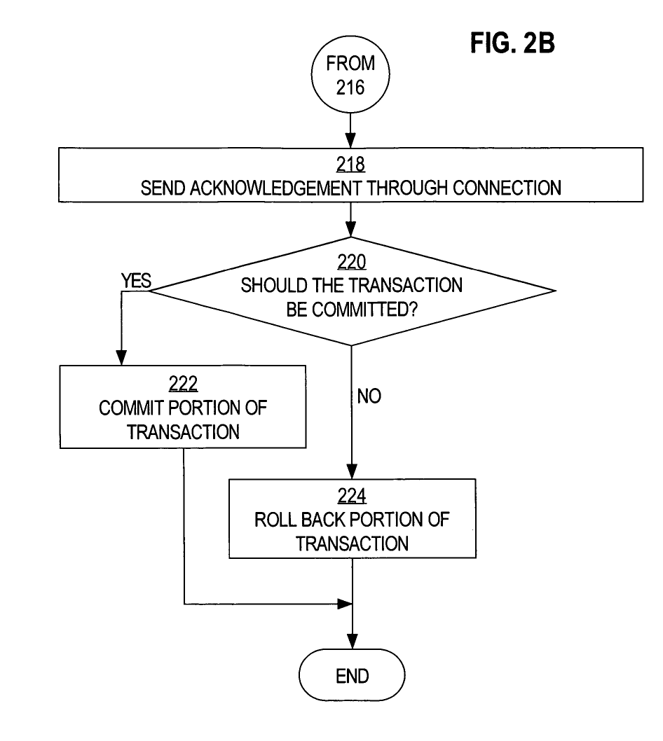

FIGS. 2A and 2B are block diagrams that illustrate a technique 200 for recovering a distributed transaction, according to an embodiment of the present invention. Technique 200 may be performed by any of resource managers 106A-N, for example.

In block 202, a transaction manager's connection information is received. The connection information indicates how to connect to the transaction manager. For example, resource manager 106A may receive connection information for transaction manager 102A from application server 104 and/or transaction manager 102A. Resource manager 106A may also receive connection information for transaction manager 102B from application server 104 and/or transaction manager 102B.

In block 204, an association is established between the transaction manager's connection information and a distributed transaction that is managed by the transaction manager. For example, resource manager 106A may associate, with connection information for transaction manager 102A, a first distributed transaction that is managed by transaction manager 102A. Resource manager 106A also may associate, with connection information for transaction manager 102A, a second distributed transaction that is also managed by transaction manager 102A. Resource manager 106A may associate, with connection information for transaction manager 102B, a third distributed transaction that is managed by transaction manager 102B.

In block 206, a “prepare” message is received from the transaction manager. The prepare message identifies the distributed transaction. In block 208, a “prepared” message is sent to the transaction manager. The “prepared” message identifies a resource manager and the distributed transaction.

In block 210, it is determined whether the commitment status of the distributed transaction is certain. If neither a “commit” nor an “abort” message identifying the distributed transaction was received from the transaction manager within a specified period of time after block 208, then the commitment status of the distributed transaction is uncertain. If the commitment status of the distributed transaction is certain, then technique 200 ends relative to the distributed transaction. Otherwise, control passes to block 212.

In block 212, a connection is established with the transaction manager based on the connection information that is associated with the distributed transaction. For example, resource manager 106A may establish an HTTP connection with transaction manager 102A based on the connection information associated with the first distributed transaction or the second distributed transaction. For another example, resource manager 106A may establish an HTTP connection with transaction manager 102B based on the connection information associated with the third distributed transaction.

In block 214, a request is sent, through the connection, for status information that indicates whether the distributed transaction should be committed. For example, resource manager 106A may send, through a connection established with transaction manager 102A, a request for status information that indicates whether the first distributed transaction should be committed, or a request for status information that indicates whether the second distributed transaction should be committed. For another example, resource manager 106A may send, through a connection established with transaction manager 102B, a request for status information that indicates whether the third distributed transaction should be committed.

In block 216, the status information is received through the connection. For example, resource manager 106A may receive such status information through the connection.

In block 218, through the connection, a message is sent that instructs the transaction manager to discontinue storing the status information. For example, resource manager 106A may send such a message through the connection. The message may be an acknowledgment that identifies resource manager 106A and the distributed transaction.

In block 220, it is determined, based on the status information, whether the distributed transaction should be committed. If the status information indicates that the distributed transaction should be committed, then control passes to block 222. Otherwise, control passes to block 224.

In block 222, a portion of the distributed transaction is committed. For example, resource manager 106A may cause the changes of its portion of the distributed transaction to be committed in data storage resource 108A. Technique 200 then ends relative to the distributed transaction.

Alternatively, in block 224, a portion of the distributed transaction is rolled back. For example, resource manager 106A may cause the changes of its portion of the distributed transaction to be rolled back in data storage resource 108A. Technique 200 then ends relative to the distributed transaction.

### Example Technique Performable by Transaction Managers

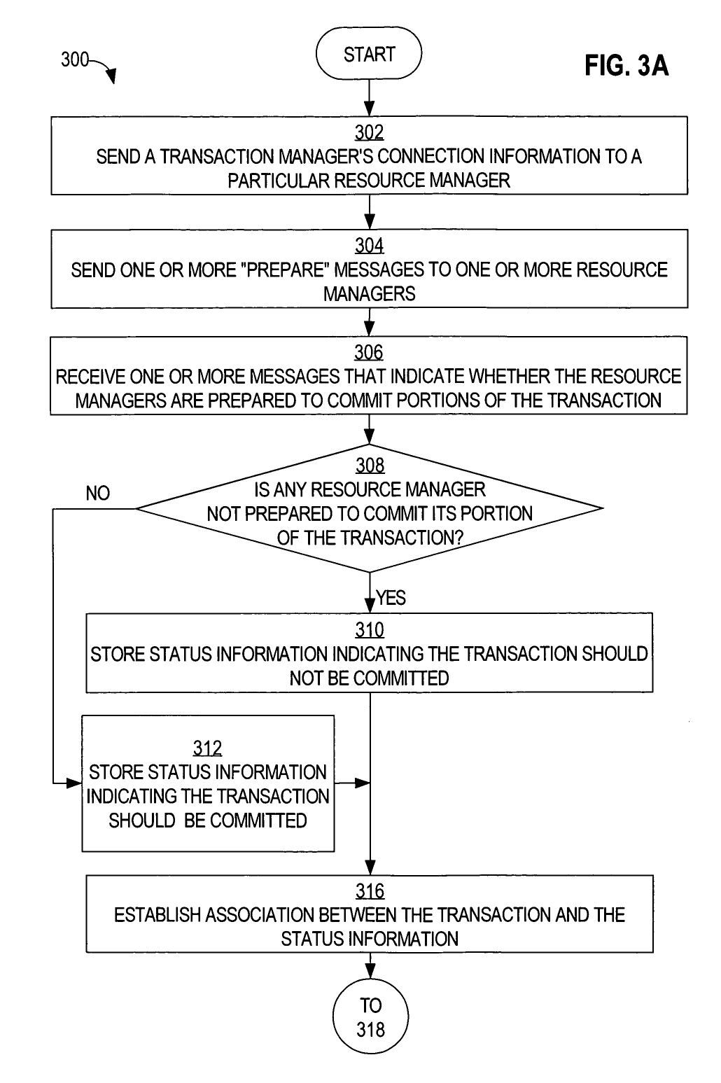

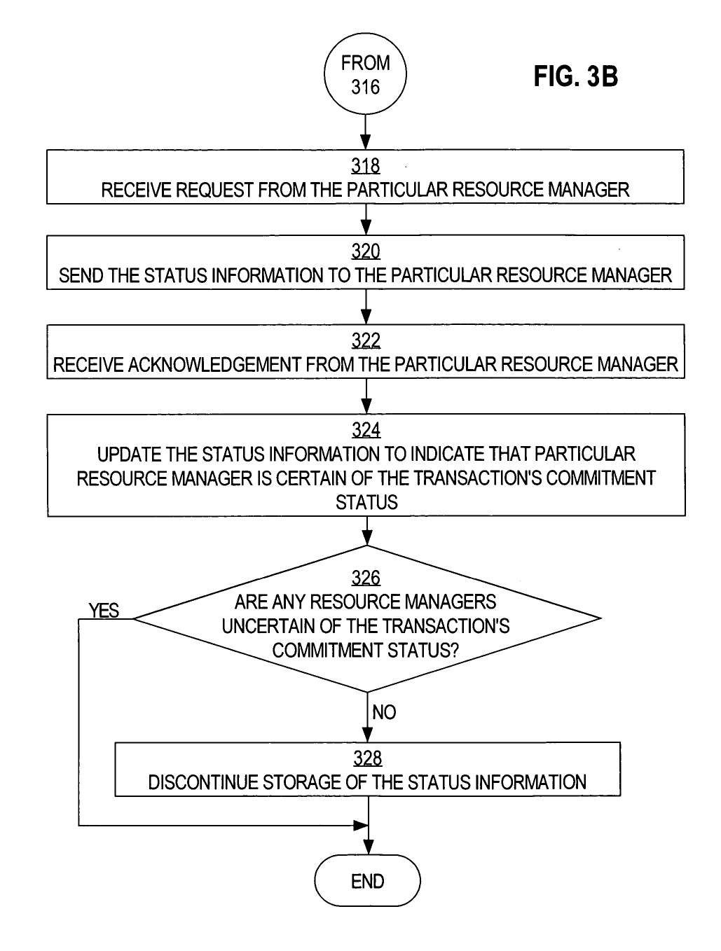

FIGS. 3A and 3B are block diagrams that illustrates a technique 300 for recovering a distributed transaction, according to an embodiment of the present invention. For example, technique 300 may be performed by any of transaction managers 102A-N.

In block 302, a transaction manager's connection information is sent to a particular resource manager. For example, transaction manager 102A may send, to resource manager 106A, connection information for transaction manager 102A. Transaction manager 102A also may send, to resource manager 106B, connection information for transaction manager 102A.

In block 304, one or more “prepare” messages are sent to one or more resource managers in the context of a distributed transaction managed by that transaction manager. Each “prepare” message to a resource manager identifies the part of the transaction manager's distributed transaction performed by that resource manager. For example, transaction manager 102A may send, to resource managers 106A-N, “prepare” messages that identify parts of a first distributed transaction performed by resource managers 106A-N, respectively. Transaction manager 102A also may send, to resource managers 106A-N, “prepare” messages that identify parts of a second distributed transaction performed by resource managers 106A-N, respectively.

In block 306, one or more messages, which indicate whether one or more resource managers are prepared to commit their portions of the distributed transaction, are received. For example, transaction manager 102A may receive, from each of resource managers 106A-N, a message that indicates whether that resource manager is prepared to commit its portion of the first distributed transaction. Transaction manager 102A also may receive, from each of resource managers 106A-N, a message that indicates whether that resource manager is prepared to commit its portion of the second distributed transaction.

In block 308, it is determined, based on the one or more messages, whether at least one resource manager is not prepared to commit its portion of the distributed transaction. For example, transaction manager 102A may make such a determination for the first distributed transaction based on messages received in relation to the first distributed transaction, and transaction manager 102A may make such a determination for the second distributed transaction based on messages received in relation to the second distributed transaction. If at least one resource manager is not prepared to commit its portion of the distributed transaction, then control passes to block 310. Otherwise, control passes to block 312.

In block 310, status information, which indicates that the distributed transaction should not be committed, is stored. For example, transaction manager 102A may store first status information that indicates that the first distributed transaction should be committed. Control passes to block 316.

Alternatively, in block 312, status information, which indicates that the distributed transaction should be committed, is stored. For example, transaction manager 102A may store second status information that indicates that the second distributed transaction should not be committed. Control passes to block 316.

In block 316, an association is established between the distributed transaction and the status information. For example, transaction manager 102A may associate the first status information with the first distributed transaction, and transaction manager may associate the second status information with the second distributed transaction.

In block 318, a request is received from the particular resource manager. The request identifies the distributed transaction. For example, transaction manager 102A may receive, from resource manager 106A, a first request that identifies the first distributed transaction. Transaction manager 102A also may receive, from resource manager 106B, a second request that identifies the second distributed transaction.

In block 320, the status information for the distributed transaction is sent to the particular resource manager. For example, transaction manager 102A may send the first status information to resource manager 106A. Transaction manager 102A also may send the second status information to resource manager 106B.

In block 322, a message is received from the particular resource manager. The message is an acknowledgement that instructs the transaction manager to discontinue storing the status information for the distributed transaction. For example, transaction manager 102A may receive, from resource manager 106A, an acknowledgment message that instructs transaction manager 102A to discontinue storing the first status information.

In block 324, status information for the distributed transaction is updated to indicate that the particular resource manager is certain of the commitment status of the distributed transaction. For example, transaction manager 102A may update the first status information to indicate that resource manager 106A is certain of the commitment status of the first distributed transaction.

In block 326, it is determined whether one or more resource managers are not certain of the commitment status of the distributed transaction. For example, transaction manager 102A may determine whether an acknowledgement for the first distributed transaction has not been received from any of resource managers 106A-N. Those resource managers from which an acknowledgement for the distributed transaction has not been received are deemed to be uncertain of the commitment status of the distributed transaction. If at least one resource manager is not certain of the commitment status of the distributed transaction, then technique 300 ends relative to the distributed transaction. Otherwise, control passes to block 328.

In block 328, storage of the status information for the distributed transaction is discontinued. For example, transaction manager 102A may erase the first status information that is associated with the first distributed transaction. Technique 300 ends relative to the distributed transaction.

### Hardware Overview

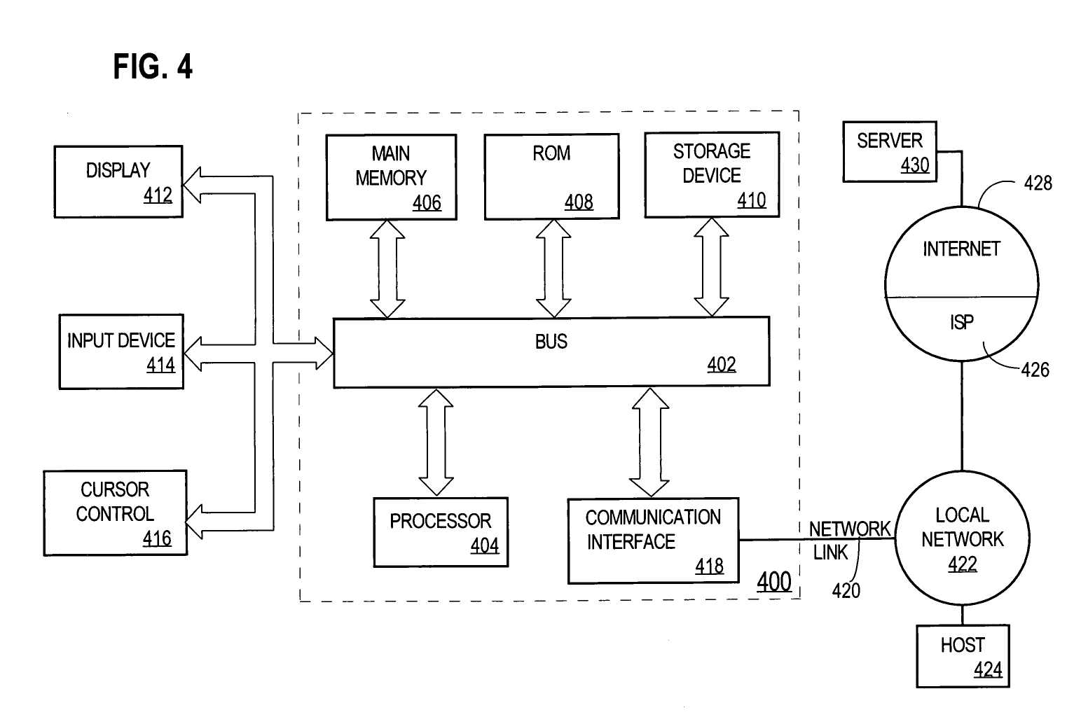

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another computer-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infrared transmitter to convert the data to an infrared signal. An infrared detector can receive the data carried in the infrared signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method of recovering distributed transactions, the method comprising:
receiving first connection information that indicates how to connect to a first transaction manager;
establishing an association between the first connection information and a first transaction that is managed by the first transaction manager;
determining whether a commitment status of the first transaction is certain; and
in response to a determination that the commitment status of the first transaction is not certain, performing steps comprising:
based on the association between the first transaction and the first connection information, establishing a first connection to the first transaction manager using the first connection information; and
sending, through the first connection, a request for first status information that indicates whether the first transaction should be committed.

2. The method of claim 1, wherein establishing the first connection comprises
establishing a connection to a machine identified in the first connection information.

3. The method of claim 1, further comprising:
receiving the first status information from the first transaction manager in response to the request.

4. The method of claim 3, further comprising:
in response to receiving the first status information, sending, through the first connection, a message that instructs the first transaction manager to discontinue storing the first status information.

5. The method of claim 3, further comprising:
determining, based on the first status information, whether the first transaction should be committed; and
in response to a determination that the first transaction should be committed, committing at least a portion of the first transaction in a data storage resource.

6. The method of claim 1, further comprising:
establishing an association between the first connection information and a second transaction that is managed by the first transaction manager, wherein the second transaction differs from the first transaction;
determining whether a commitment status of the second transaction is certain; and
in response to a determination that the commitment status of the second transaction is not certain, sending, through the first connection, a request for second status information that indicates whether the second transaction should be committed.

7. The method of claim 1, further comprising:
receiving second connection information that indicates how to connect to a second transaction manager that is separate from the first transaction manager;
establishing an association between the second connection information and a second transaction that is managed by the second transaction manager;
determining whether a commitment status of the second transaction is certain; and
in response to a determination that the commitment status of the second transaction is not certain, performing steps comprising:
based on the association between the second transaction and the second connection information, establishing a second connection to the second transaction manager using the second connection information; and
sending, through the second connection, a request for second status information that indicates whether the second transaction should be committed.

8. A method of performing distributed transactions, the method comprising:
sending, to a first resource manager participating in a first transaction, connection information that indicates how to connect to a transaction manager;
receiving one or more first messages that indicate whether one or more resource managers that are participating in the first transaction are prepared to commit respective portions of the first transaction;
determining, based on the one or more first messages, whether at least one resource manager is not prepared its portion of to commit the first transaction;
based on the one or more first messages, storing first status information that indicates whether the first transaction should be committed;
establishing an association between the first transaction and the first status information;
receiving, from the first resource manager, a first request that identifies the first transaction; and
in response to receiving the first request, sending the first status information to the first resource manager.

9. The method of claim 8, wherein the first connection information identifies a machine on which the transaction manager executes.

10. The method of claim 9, further comprising:
receiving, from the first resource manager, a particular message that instructs the transaction manager to discontinue storing the first status information; and
in response to receiving the particular message, storing an indication that the first resource manager is certain of a commitment status of the first transaction.

11. The method of claim 10, further comprising:
determining whether any resource managers that participated in the first transaction are not certain of the commitment status of the first transaction; and
in response to a determination that all resource managers that participated in the first transaction are certain of the commitment status of the first transaction, discontinuing storage of the first status information.

12. The method of claim 10, further comprising:
receiving one or more second messages that indicate whether one or more resource managers are prepared to commit a second transaction that differs from the first transaction;
determining, based on the one or more second messages, whether at least one resource manager is not prepared to commit the second transaction;
storing second status information that indicates, based on a determination of whether at least one resource manager is not prepared to commit the second transaction, whether the second transaction should be committed;
establishing an association between the second transaction and the second status information;
receiving, from the first resource manager, a second request that identifies the second transaction; and
in response to receiving the second request, sending the second status information to the first resource manager.

13. The method of claim 10, further comprising:
sending the connection information to a second resource manager that is separate from the first resource manager;
receiving, from the second resource manager, a second request that identifies the first transaction; and
in response to receiving the second request, sending the first status information to the second resource manager.

14. The method of claim 1, wherein receiving the first connection information comprises:
receiving the first connection information with a request to perform one or more operations of the first transaction.

15. The method of claim 1, wherein the first transaction is a distributed transaction that involves a plurality of resource managers, and wherein the steps of receiving, establishing the association, determining, establishing the first connection, and sending are performed by a particular resource manager of the plurality of resource managers.

16. A computer-readable medium carrying one or more sequences of instructions which, when executed by one or more processors, causes the one or more processors to perform the method recited in claim 1.

17. A computer-readable medium carrying one or more sequences of instructions which, when executed by one or more processors, causes the one or more processors to perform the method recited in claim 2.

18. A computer-readable medium carrying one or more sequences of instructions which, when executed by one or more processors, causes the one or more processors to perform the method recited in claim 3.

19. A computer-readable medium carrying one or more sequences of instructions which, when executed by one or more processors, causes the one or more processors to perform the method recited in claim 4.

20. A computer-readable medium carrying one or more sequences of instructions which, when executed by one or more processors, causes the one or more processors to perform the method recited in claim 5.

21. A computer-readable medium carrying one or more sequences of instructions which, when executed by one or more processors, causes the one or more processors to perform the method recited in claim 6.

22. A computer-readable medium carrying one or more sequences of instructions which, when executed by one or more processors, causes the one or more processors to perform the method recited in claim 7.

23. A computer-readable medium carrying one or more sequences of instructions which, when executed by one or more processors, causes the one or more processors to perform the method recited in claim 8.

24. A computer-readable medium carrying one or more sequences of instructions which, when executed by one or more processors, causes the one or more processors to perform the method recited in claim 9.

25. A computer-readable medium carrying one or more sequences of instructions which, when executed by one or more processors, causes the one or more processors to perform the method recited in claim 10.

26. A computer-readable medium carrying one or more sequences of instructions which, when executed by one or more processors, causes the one or more processors to perform the method recited in claim 11.

27. A computer-readable medium carrying one or more sequences of instructions which, when executed by one or more processors, causes the one or more processors to perform the method recited in claim 12.

28. A computer-readable medium carrying one or more sequences of instructions which, when executed by one or more processors, causes the one or more processors to perform the method recited in claim 13.

29. A computer-readable medium carrying one or more sequences of instructions which, when executed by one or more processors, causes the one or more processors to perform the method recited in claim 14.

30. A computer-readable medium carrying one or more sequences of instructions which, when executed by one or more processors, causes the one or more processors to perform the method recited in claim 15.
